(19) United States
(12) Patent Application Publication
(10) Pub. No.: US 2007/0169369 A1
(43) Pub. Date: Jul. 26, 2007

(54) Hair Drier with 3-Dimensional Control Surface

(75) Inventors: Chin Yun Lok, New Territories (HK); Wai Ho Michael Keong, New York (HK); Chi Sang Tam, New Territories (HK); Wai Ming Lam, New Territories (HK)

Correspondence Address: INTELLECTUAL PROPERTY LAW GROUP LLP, 12 SOUTH FIRST STREET, SUITE 1205, SAN JOSE, CA, 95113, US

(73) Assignee: KENFORD INDUSTRIAL CO. LTD., New Territories (HK)

(21) Appl. No.: 11/623,038

(22) Filed: Jan. 12, 2007

(30) Foreign Application Priority Data
Jan. 26, 2006 (CN) 200620005001.6

(51) Int. Cl. A45D 20/12; F26B 21/00

(52) U.S. Cl. 34/97; 34/524

(57) ABSTRACT

The present invention relates to a hair drier with a 3-Dimensional control interface, comprising a housing, a control button, a power supply, a heating element and a control circuit. An electrical connection is set among the power supply, the heating element and the control circuit. The control button has a 3-D control interface and can control each functional element of the hair drier separately or synchronously. This hair drier is single-key controlled and various functions of the hair drier can be realized by easily changing the angle of the button to a different direction, or moving the button towards different directions. This hair drier is simple in structure, easy to operate and convenient to use.

### CROSS-REFERENCE TO RELATED APPLICATIONS

This application claims foreign priority under 35 U.S.C. § 119 to Chinese Patent Application no. 20060005001.6, filed in the People's Republic of China on Jan. 26, 2006, the entire contents of which are hereby incorporated by reference.

### BACKGROUND OF THE INVENTION

1. Field of the Invention

The present invention relates to a hair drier, and in particular, to a hair drier with a three dimensional (3-D) control interface.

2. Related Art

The speed of blow and the heat of temperature of a traditional hair drier are controlled by multiple mechanical switches. During the operation of a traditional hair drier, the user does not have the option or convenience of adjusting air blow and temperature concurrently, especially when the user has a comb in one hand and a drier in another hand. If the user wants to adjust a function of a traditional hair drier, it would be very inconvenient because the user would have to stop combing. Additionally, even a traditional hair drier that has a multi-step switch to control the blow and temperature, cannot yield the exact desired setting; as that value is controlled by experience. China patent no. CN2577655 discloses a hair drier with a control display device, in which a display element is just added on the drier to read the data of air blow and temperature, however, such a device fails to simplify the operation interface to realize single hand manipulation.

### SUMMARY OF THE INVENTION

The object of the present invention is to provide a hair drier with a 3-D control interface to overcome the disadvantages of the prior art. An embodiment of the present invention comprises of a display and a single-key operation which is utilized to control the on/off function, speed of air blow, and temperature.

The technical features of an embodiment of the present invention provide a hair drier with a 3-D control interface comprising a housing, a control button, a power supply, a heating element and a control circuit. An electric connection is set among the power supply, the heating element and the control circuit, wherein the control button is a 3-D control interface. Each functional element of the hair drier can be controlled by the button separately or synchronously.

Advantageously, the button of the hair drier can control at least one functional element or at least two settings of a functional element of the hair dryer separately or synchronously.

Advantageously, the functions controlled by the button of the hair drier include adjusting the heat of air temperature and/or the speed of air blow.

Advantageously, the button of the hair drier can achieve various predetermined functions by changing the angle of the button. The angle of the button can be changed in different directions, for instance in at least 3 different directions in 3-D space, including directions of +X, −X, +Y, −Y, +Z, and −Z based on the center of the same button. In addition, the button can be changed in the directions of +X, −X, +Y, −Y along the +Z and −Z directions.

Advantageously, the button of the hair drier can achieve various predetermined functions by being moved towards different directions. The button can be moved to different directions on at least three different directions in 3-D space, including directions of +X, −X, +Y, −Y, +Z, and −Z based on the center of the same button The button can also be moved in the directions of +X, −X, +Y, −Y along +Z and −Z directions.

Advantageously, the hair drier further comprises a switch device on its housing.

Advantageously, the hair drier further comprises of an electronic display providing a visual indication of controlling the temperature and/or speed of air blow. The display is set on the housing and is electrically connected to the control circuit.

Advantageously, the hair drier further comprises of an ion generator to generate negative ions for sterilization. The ion generator is set on the housing and electrically connected to the control circuit.

Advantageously, the button of the hair drier can be in the shape of a strip, circle, cross or any other suitable shape.

Advantageously, the button of the hair drier has background lighting for clearer indication of operation.

By using the single-key control of the present invention, various functions of the hair drier can be achieved by easily changing the angle of the button to a different direction, or moving the button towards a different direction. This hair drier is simple in structure, easy to operate and convenient to use.

These and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 is a structural view of one embodiment of the present invention;

FIG. 2 is a three dimensional sectional view of the housing in one embodiment of the present invention;

FIGS. 3a and 3b are side views of the button in one embodiment of the present invention;

FIGS. 4a, 4b, and 4c are three dimensional views of the button in one embodiment of the present invention;

FIG. 5a is a front view of the button in one embodiment of the present invention;

FIGS. 5b and 5d are side views of the button in one embodiment of the present invention when in use;

FIG. 5c is a top view of the button in one embodiment of the present invention;

FIG. 6a is a front view of the hair drier in one embodiment of the present invention;

FIG. 6b is a side view of the hair drier in one embodiment of the present invention;

FIG. 6c is a back view of the hair drier in one embodiment of the present invention;

FIG. 7 is the circuit of the hair drier in one embodiment of the present invention;

FIGS. 8a and 8b are different embodiments of the configuration of the button of the present invention.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

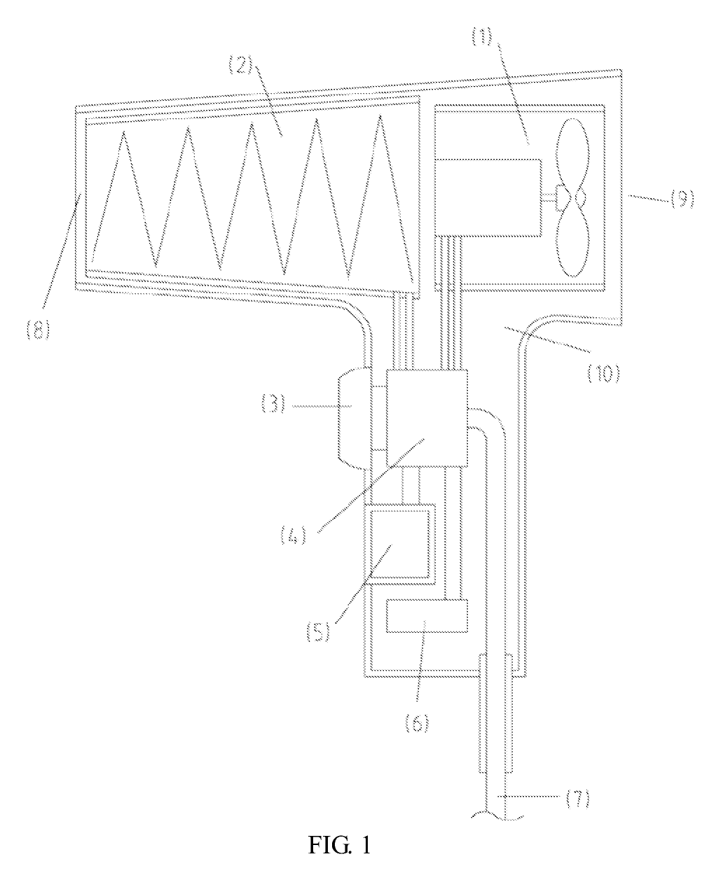

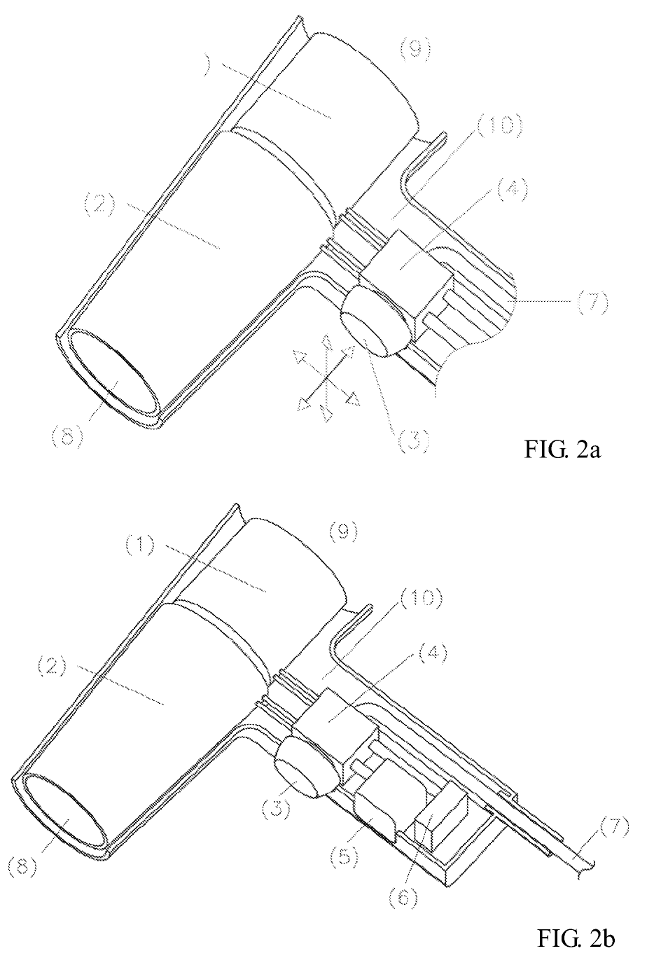

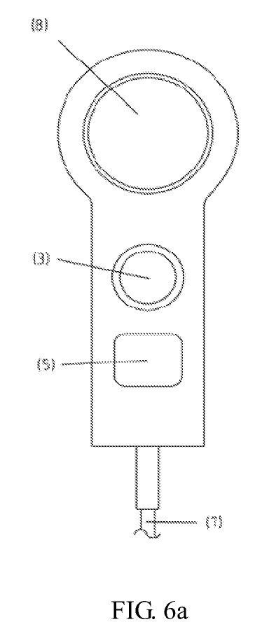

As shown in FIG. 1, the hair drier with 3-D control interface of an embodiment of the present invention comprises a fan 1, a heating wire 2, a control button 3, a control circuit 4, a display panel 5, other related devices 6 (such as an ion generator, a digital display, an LED), a power supply 7, an air outlet 8, an air inlet 9, and a housing 10 of the hair drier. The fan 1, heating wire 2, control circuit 4 and other related devices 6 are installed in the preset positions, the control button 3 and display panel 5 are set in the preset positions on the surface of the housing (referring to FIGS. 2a, 2b, 6a-6c). The fan 1, heating wire 2, control button 3, display panel 5, other related devices 6 and power supply 7 are electrically connected to control circuit 4. Control button 3 is a 3-D control interface and can have a displacement in three dimensional space towards the directions of +X, −X, +Y, −Y, +Z, −Z based on the center of the button (referring to FIG. 2). When the button 3 is in a different position, it can conduct or cut off different circuits of the control circuit 4. Additionally, based on the predetermined function of the circuits, the button 3 can realize the adjustment of each functional element of the hair drier, such as switching the power on and off, the speed of air blow, the air temperature, the content or manner of the display panel, etc.

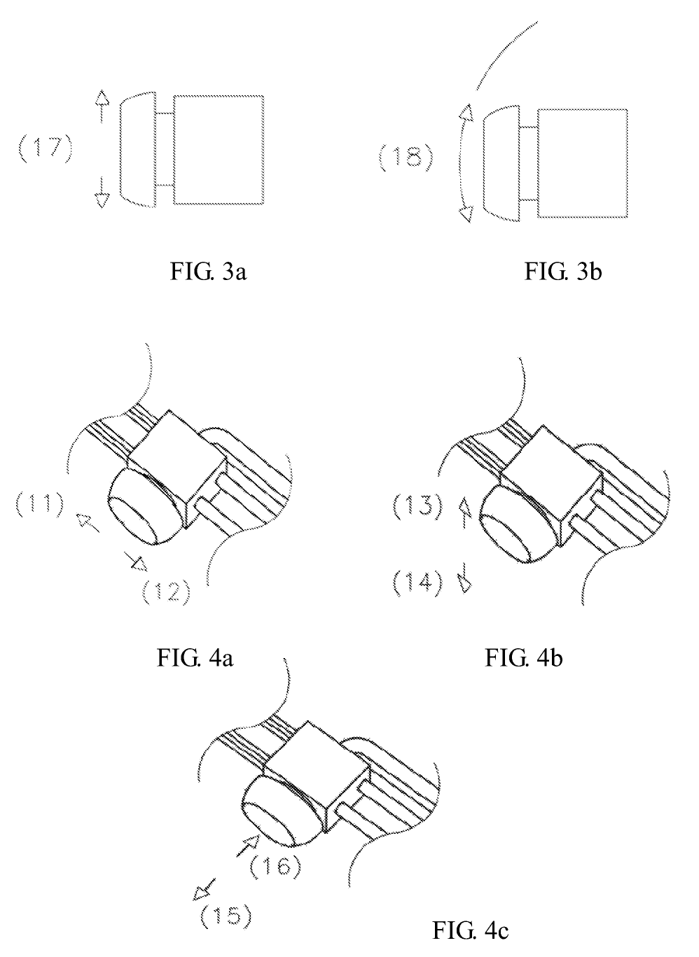

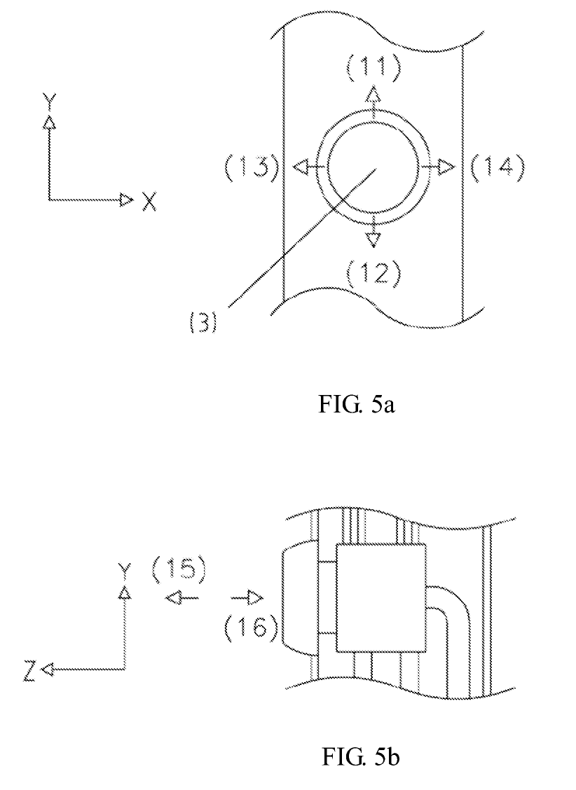

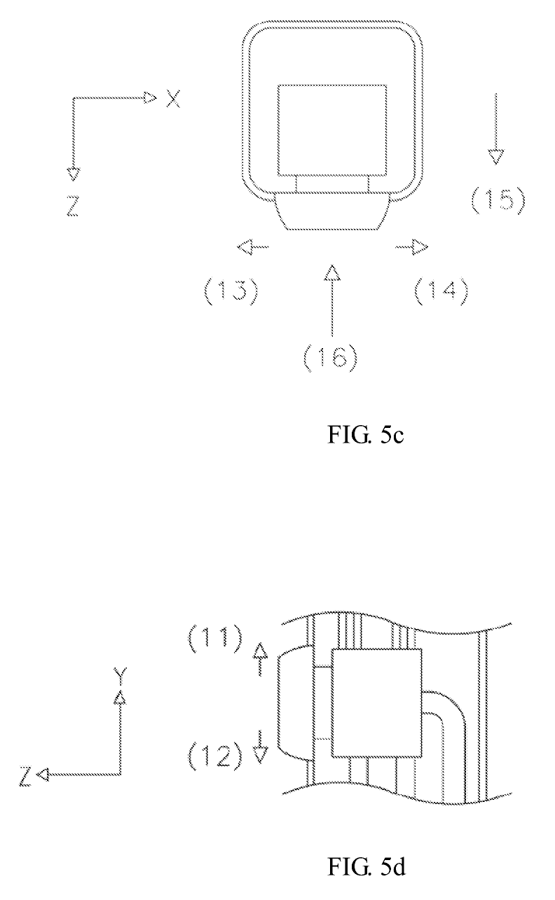

The displacement of the control button 3 can be achieved either by the relative change of position 17 (referring to FIG. 3a) or by the change of the angle 18 of the button (referring to FIG. 3b). The angle change or the position movement of the button can be in the direction of +X, −X, +Y, −Y, +Z or −Z, that is, a change/move to left 13 or right 14 on the X direction, a change/move to up 11 or down 12 on the Y direction, or a change/move to front 15 or back 16 on the Z direction. The button can also be moved in the directions of +X, −X, +Y, −Y along +Z and −Z directions (referring to FIGS. 4a-4c, 5a-5d).

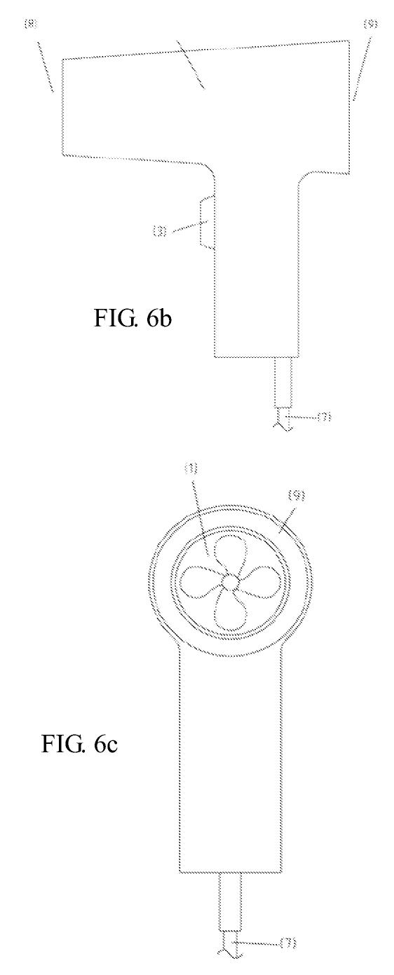

The circuit of the hair drier in one embodiment of the present invention is shown in FIG. 7.

In another embodiment, there is a separate power control button to switch the on/off power supply safely and rapidly, to prevent misoperation.

In another embodiment, a minimized negative ion generator is connected to the control button 3 and control circuit 4. Therefore, the air blown from the hair drier will be negatively ionized. Alternatively, the air blown from the hair drier can sterilize the surface of hair, skin, food or other suitable objects.

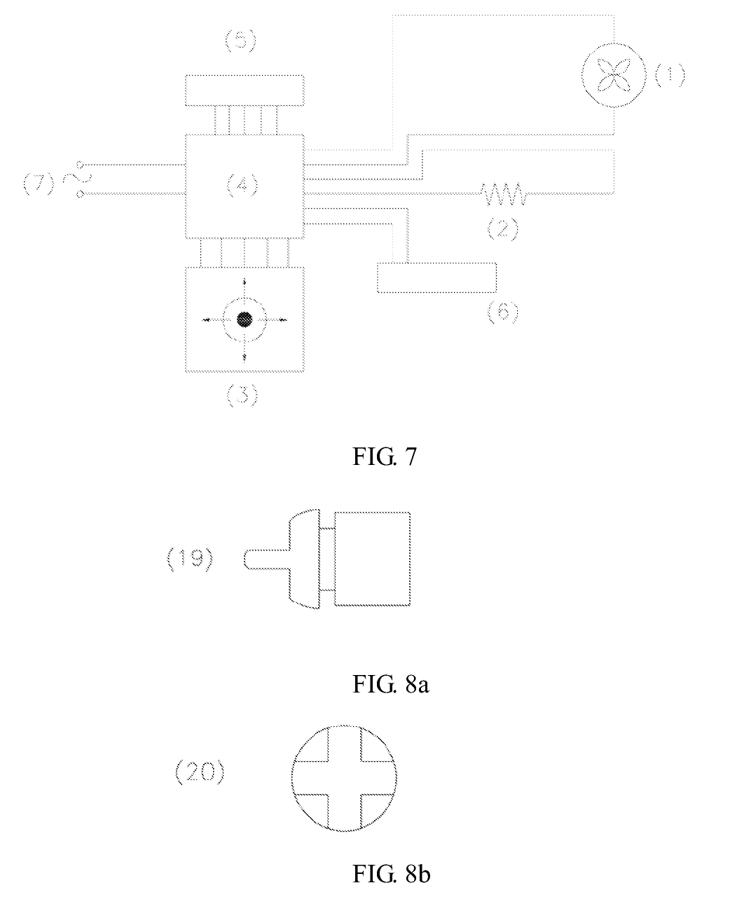

In any embodiment of the present invention, the shape of the button can be a strip, stick, circle, cross or any other shape to meet the requirements of its different usages. FIGS. 8a and 8b is an example of configurations of the button according to embodiments of the present invention, where a side view of a protruding stick shape 19 of the button is shown, and where a front view of a cross shape 20 of the button is shown.

In another embodiment, alternatively, a background light is set on the button to clearly indicate the operation of the button when in a dark environment.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description, but rather is indicated by the appended claims. All changes that come within the meaning and range of equivalents within the claims are intended to be considered as being embraced within the spirit and scope of the claims.

What is claimed is:

1. A hair drier having a plurality of functional elements, the hair dryer comprising a housing, a control button, a power supply, a heating element and a control circuit, wherein the power supply, the heating element and the control circuit are electrically connected, wherein the control button is a multi-dimensional control interface capable of controlling each of the plurality of functional elements of the hair drier separately and capable of controlling each of the plurality of functional elements of the hair synchronously.

2. The hair drier according to claim 1, wherein the multi-dimensional control interface is at least a three-dimensional control interface.

3. The hair drier as in claim 1, wherein the button controls at least one functional element or at least two settings of a functional element of the hair dryer separately and alternatively, synchronously.

4. The hair drier as in claim 1, wherein the functional element controlled by the button is temperature of air blow of the hair drier.

5. The hair drier as in claim 1, wherein the functional element controlled by the button is speed of air blow of the hair drier.

6. The hair drier as in claim 1, wherein an angle of the button is adjustable towards different directions to control different functions of the hair drier.

7. The hair drier as in claim 6, wherein the angle of the button is adjustable in at least three different directions in 3-D space, including directions of +X, −X, +Y, −Y, +Z, −Z based on a center of the button, and directions of +X, −X, +Y, −Y along the +Z and −Z directions.

8. The hair drier as in claim 1, wherein the button is movable towards different directions to control different functions of the hair drier.

9. The hair drier as in claim 8, wherein the movement of the button is in at least three different directions in 3-D space, including directions of +X, −X, +Y, −Y, +Z, −Z based on a center of the button, and directions of +X, −X, +Y, −Y along the +Z and −Z directions.

10. The hair drier as in claim 1, further comprising a switch device set on the housing.

11. The hair drier as in claim 1, further comprising an electronic display set on the housing for visual indication of the control of the hair drier.

12. The hair drier as in claim 1, further comprising an ion generator set inside the housing that is electrically connected to said control circuit.

13. The hair drier as in claim 1, wherein a shape of the button is in the shape of a stick, a strip, a circle or a cross.

14. The hair drier as in claim 1, further comprising a background lighting device set on the button.
